(19) United States
(12) Patent Application Publication
(10) Pub. No.: US 2025/0370133 A1
(43) Pub. Date: Dec. 4, 2025

(54) DISTANCE MEASUREMENT DEVICE, DISTANCE MEASUREMENT METHOD, AND PROGRAM

(71) Applicant: FUJIFILM Corporation, Tokyo (JP)

(72) Inventors: Yuya ISHIZUKA, Kanagawa (JP); Yosuke NISHIURA, Kanagawa (JP); Kentaro MIYAMOTO, Kanagawa (JP)

(73) Assignee: FUJIFILM Corporation, Tokyo (JP)

(21) Appl. No.: 19/299,364

(22) Filed: Aug. 14, 2025

Related U.S. Application Data
(63) Continuation of application No. PCT/JP2023/046628, filed on Dec. 26, 2023.

(30) Foreign Application Priority Data
Feb. 17, 2023 (JP) 2023-023520

(51) Int. Cl. G01S 17/10; G01S 7/481; G01S 7/4865; G01S 17/32

(52) U.S. Cl. CPC G01S 17/10; G01S 7/4817; G01S 7/4865; G01S 17/32

(57) ABSTRACT

Provided are a distance measurement device, a distance measurement method, and a program capable of performing measurement robust to a change in a distance to a measurement object. A distance measurement device includes a first distance measurement sensor, a second distance measurement sensor, and a processor, in which the first distance measurement sensor is a frequency-modulated continuous wave (FMCW) LiDAR, and includes a focus adjustment mechanism that adjusts a focus position of laser light for measurement and that focuses the laser light for measurement on a surface of a measurement object, the second distance measurement sensor is configured as a LiDAR having lower measurement accuracy and a wider measurement distance range than the first distance measurement sensor, and the processor is configured to control the focus adjustment mechanism based on a distance to the surface of the measurement object, which is obtained from the second distance measurement sensor.

### CROSS-REFERENCE TO RELATED APPLICATIONS

The present application is a Continuation of PCT International Application No. PCT/JP2023/046628 filed on Dec. 26, 2023 claiming priority under 35 U.S.C § 119 (a) to Japanese Patent Application No. 2023-023520 filed on Feb. 17, 2023. Each of the above applications is hereby expressly incorporated by reference, in its entirety, into the present application.

### BACKGROUND OF THE INVENTION

### 1. Field of the Invention

The present invention relates to a distance measurement device, a distance measurement method, and a program.

### 2. Description of the Related Art

In recent years, inspection of structural damage or aging deterioration has been performed by measuring a shape of the structure using light detection and ranging (LiDAR). Here, LiDAR employs various schemes depending on a difference in distance measurement. For example, a time-of-flight (ToF) LiDAR and a frequency-modulated continuous wave (FMCW) LiDAR are known.

WO2022/209309A discloses a distance measurement device employing a frequency-modulated continuous wave (FMCW) LiDAR.

### SUMMARY OF THE INVENTION

Here, an attempt has been made to detect a defect called delamination by measuring the shape of the structure such as a bridge or a tunnel with the LiDAR. Specifically, the delamination is detected by measuring an uneven shape of a surface of the structure with the LiDAR having high measurement accuracy. Therefore, it is necessary to measure a surface shape of the structure with high accuracy in order to detect the delamination.

However, the structure under measurement may have diverse shapes, and its distance from the measurement device is not constant. Depending on the shape of the structure, the distance from the measurement device to the structure may be changed suddenly. Meanwhile, high-accuracy LiDARs require precise focusing of the light from the light source on the surface of the measurement object to maintain adequate S/N ratio, which limits their measurement range.

Therefore, in a case in which the shape of the structure changes and the structure is out of the measurable range of the LiDAR, highly accurate measurement cannot be performed.

The present invention has been made in view of such circumstances, and an object of the present invention is to provide a distance measurement device, a distance measurement method, and a program capable of performing measurement robust to a change in a distance to a measurement object.

In order to achieve the above-described object, a first aspect of the present invention provides a distance measurement device comprising: a first distance measurement sensor; a second distance measurement sensor; and a processor, in which the first distance measurement sensor is a frequency-modulated continuous wave (FMCW) LiDAR, and includes a focus adjustment mechanism that adjusts a focus position of laser light for measurement and that focuses the laser light for measurement on a surface of a measurement object, the second distance measurement sensor is configured as a LiDAR having lower measurement accuracy and a wider measurement distance range than the first distance measurement sensor, and the processor is configured to control the focus adjustment mechanism based on a distance to the surface of the measurement object, which is obtained from the second distance measurement sensor.

A second aspect provides the distance measurement device according to the first aspect, in which it is preferable that, in the first distance measurement sensor, a frequency-shifted feedback laser (FSF laser) is employed as the laser light for measurement.

A third aspect provides the distance measurement device according to the first aspect, in which it is preferable that the second distance measurement sensor is configured as a time-of-flight (ToF) LiDAR.

A fourth aspect provides the distance measurement device according to the first aspect preferably further comprising: a first position measurement device that acquires first positional information of the first distance measurement sensor; and a second position measurement device that acquires second positional information of the second distance measurement sensor, in which the processor is configured to: acquire the distance in association with the second positional information; and acquire the distance based on the first positional information, to drive the focus adjustment mechanism.

A fifth aspect provides the distance measurement device according to the fourth aspect, in which it is preferable that the first position measurement device and the second position measurement device are integrated together.

A sixth aspect provides the distance measurement device according to the first aspect, in which it is preferable that the second distance measurement sensor includes a scanner, and acquires the distance by changing an irradiation angle of laser light by the scanner, and the processor is configured to acquire the irradiation angle and the distance in association with each other.

A seventh aspect provides the distance measurement device according to the fourth or fifth aspect, in which it is preferable that the first distance measurement sensor includes a scanner, and the processor is configured to acquire the distance based on a scanning angle of the scanner and the first positional information.

An eighth aspect provides the distance measurement device according to the first aspect, in which it is preferable that the measurement object is a concrete structure, a metal member, or a plastic member.

A ninth aspect provides a distance measurement method of a distance measurement device including: a first distance measurement sensor; a second distance measurement sensor; and a processor, in which the first distance measurement sensor is a frequency-modulated continuous wave (FMCW) LiDAR, and includes a focus adjustment mechanism that adjusts a focus position of laser light for measurement and that focuses the laser light for measurement on a surface of a measurement object, and the second distance measurement sensor is configured as a LiDAR having lower measurement accuracy and a wider measurement distance range than the first distance measurement sensor, the distance measurement method comprising: a step of controlling, via the processor, the focus adjustment mechanism based on a distance to the surface of the measurement object, which is obtained from the second distance measurement sensor.

A tenth aspect provides a program for executing a distance measurement method of a distance measurement device including: a first distance measurement sensor; a second distance measurement sensor; and a processor, in which the first distance measurement sensor is a frequency-modulated continuous wave (FMCW) LiDAR, and includes a focus adjustment mechanism that adjusts a focus position of laser light for measurement and that focuses the laser light for measurement on a surface of a measurement object, and the second distance measurement sensor is configured as a LiDAR having lower measurement accuracy and a wider measurement distance range than the first distance measurement sensor, the program causing the processor to execute a process comprising: a step of controlling the focus adjustment mechanism based on a distance to the surface of the measurement object, which is obtained from the second distance measurement sensor.

According to the present invention, the focus adjustment mechanism of the first distance measurement sensor is controlled based on the distance to the surface of the measurement object, which is obtained from the second distance measurement sensor, and the distance to the surface of the measurement object is acquired by the first distance measurement sensor, so that it is possible to perform the measurement robust to the change in the distance to the measurement object.

### BRIEF DESCRIPTION OF THE DRAWINGS

FIG. 1 is a conceptual diagram showing a distance measurement device.

FIG. 2 is a diagram showing a configuration of a ToF LiDAR.

FIG. 3 is a diagram showing a configuration of an FMCW LiDAR.

FIG. 4 is a block diagram showing a hardware configuration example of a control device and main functions implemented by a processor.

FIG. 5 is a diagram showing control of a focus adjustment mechanism in the distance measurement device.

FIG. 6 is a diagram showing a storage configuration example of table data.

FIG. 7 is a diagram showing a shape of a wall surface T measured by the ToF LiDAR and a focus position of the FMCW LiDAR.

FIG. 8 is a flowchart showing a distance measurement method.

FIG. 9 is a diagram showing control of the focus adjustment mechanism.

### DESCRIPTION OF THE PREFERRED EMBODIMENTS

Hereinafter, preferred embodiments of a distance measurement device, a distance measurement method, and a program according to embodiments of the present invention will be described with reference to the accompanying drawings.

### <Distance Measurement Device>

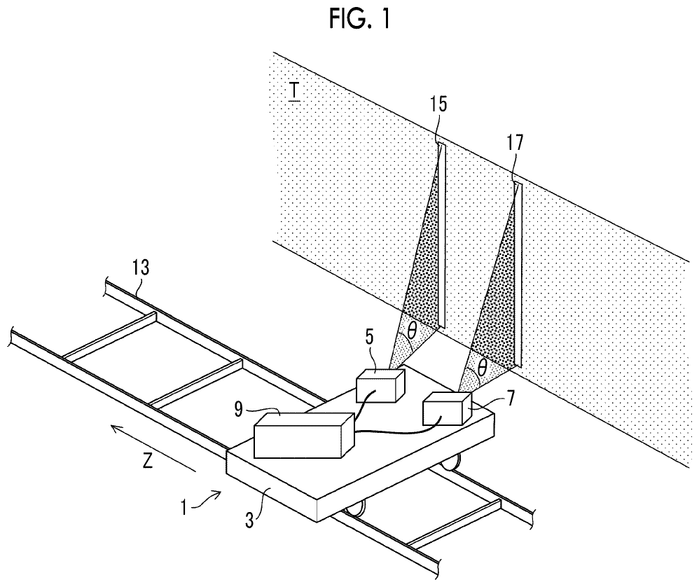

FIG. 1 is a conceptual diagram showing a distance measurement device according to one embodiment of the present invention.

A distance measurement device 1 comprises a time-of-flight (ToF) LiDAR (second distance measurement sensor) 5, a frequency-modulated continuous wave (FMCW) LiDAR (first distance measurement sensor) 7, and a control device 9. It should be noted that, in FIG. 1, the distance measurement device 1 is installed on a cart 3. The cart 3 travels on a railroad 13 in a positive direction of a Z-axis. Then, the distance measurement device 1 installed on the cart 3 acquires a distance to an inner wall surface T (hereinafter simply referred to as a wall surface T) of a structure (tunnel) which is a measurement object with high accuracy. In this way, the distance to the wall surface T is acquired by the distance measurement device 1, and shape information of the wall surface Tis acquired, so that damage (for example, delamination) can be detected. It should be noted that, in the following example, a concrete tunnel will be described as a specific example of the structure, but the measurement object to which the present invention is applied is not limited thereto. For example, a metal member, a plastic member, or the like can also be the measurement object according to the embodiment of the present invention.

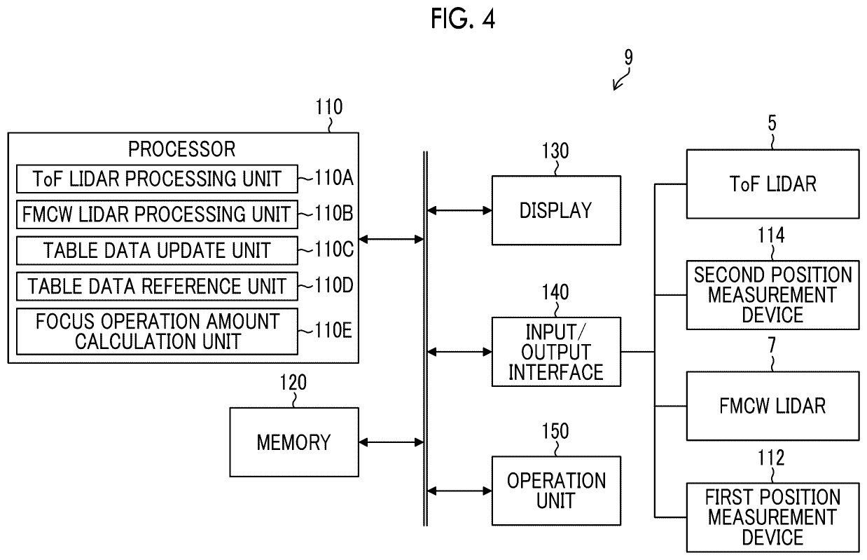

The distance measurement device 1 first acquires the distance to the wall surface T by the ToF LiDAR 5, adjusts a focus mechanism of the FMCW LiDAR 7 based on the distance acquired by the ToF LiDAR 5, and measures the distance by the FMCW LiDAR 7. Therefore, it is preferable that the ToF LiDAR 5 is disposed on the front side in a traveling direction with respect to the FMCW LiDAR 7. In addition, the positional information of the ToF LiDAR 5 and the FMCW LiDAR 7 is acquired by a first position measurement device 112 and a second position measurement device 114 (not shown in FIG. 1, see FIG. 4), and information related to a positional relationship between the ToF LiDAR 5 and the FMCW LiDAR 7 is stored in advance in a memory 120 of the control device 9.

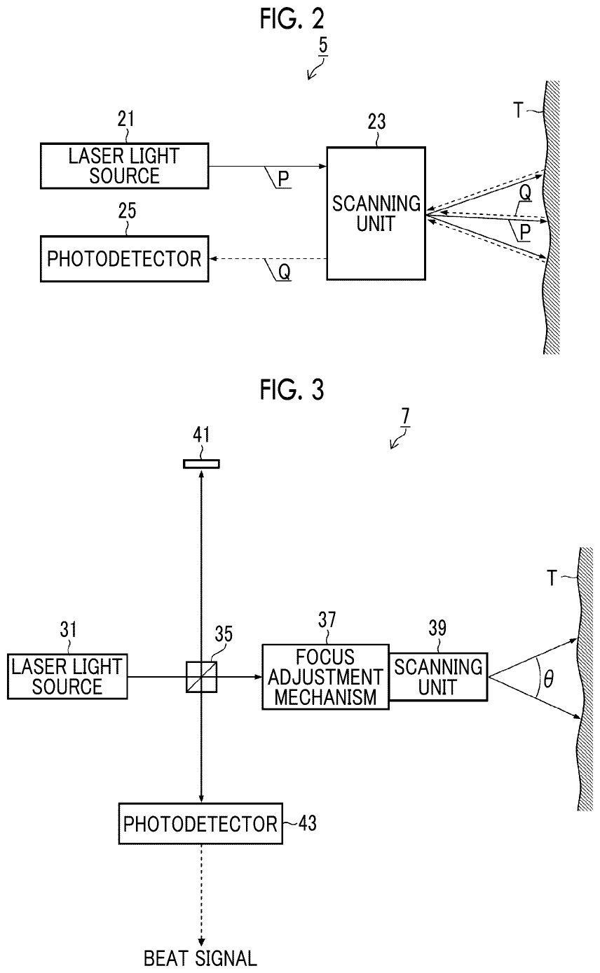

In addition, FIG. 1 shows a scanning line 15 of the ToF LiDAR 5 and a scanning line 17 of the FMCW LiDAR 7 at a certain position of the cart. As described above, the distance is measured at a plurality of measurement points by sequentially changing a scanning angle (irradiation angle) θ and performing the scanning on the wall surface T by using a scanning unit (scanner) 23 (see FIG. 2) in the ToF LiDAR 5 and a scanning unit (scanner) 39 (see FIG. 3) in the FMCW LiDAR 7.

Here, in the distance measurement device 1, a highly accurate distance, which is measured by the FMCW LiDAR 7, can be acquired in a state in which the focus position is aligned with the wall surface T that is the measurement object. Therefore, the distance acquired by the distance measurement device 1 is used in a case of detecting damage such as delamination of the wall surface T. Hereinafter, a case will be described in which damage such as delamination of the wall surface T is detected by the distance acquired by the distance measurement device 1.

The control device 9 detects a frequency (beat frequency) of a beat signal output from the scanning unit 39 of the FMCW LiDAR 7 in which the focus position aligns the wall surface T by frequency analysis, and measures the distance to the measurement point on each scanning line of the laser light based on the detected beat frequency.

Then, the control device 9 measures the distance of laser light emitted from the scanning unit 39 to a large number of measurement points on each scanning line (that is, on the wall surface T), to acquire three-dimensional measurement data of a polar coordinate system consisting of an irradiation direction of the laser light and a measurement distance (three-dimensional measurement data of the polar coordinate system indicating the surface shape of the wall surface T). The control device 9 acquires the three-dimensional measurement data indicating the shape of the wall surface T by converting the three-dimensional measurement data of the polar coordinate system into three-dimensional data of an orthogonal coordinate system.

Further, by calculating the distance (height from a reference surface) in a normal direction of the three-dimensional measurement data with respect to a defined reference surface of the wall surface T, an amount of rise (amount of delamination) of the wall surface T can be detected. As described above, the delamination can be detected with high accuracy by the highly accurate distance acquired by the distance measurement device 1.

The three-dimensional measurement data (point cloud data) of a large number of measurement points on the wall surface T is acquired as the three-dimensional measurement data measured by the FMCW LiDAR 7 of the present example as described above, but it is considered to perform the measurement under the following conditions in order to measure a minute uneven shape of the wall surface T.
Measurement accuracy: 50 μm
Measurement distance: 2 m to 7 m
Measurement speed: 10 m²/sec in terms of area (speed of laser light is equivalent to 4000 rpm)

The scanning unit 39 is a measurement head of the FMCW LiDAR 7, and continuously transmits (emits) the laser light while frequency-modulating the frequency of the laser light over a certain period.

### <ToF LiDAR>

The measurement distance range of the ToF LiDAR 5 is longer than the measurement distance range of the FMCW LiDAR 7, and the measurement accuracy is lower than the measurement accuracy of the FMCW LiDAR 7. For example, the measurement distance range of the ToF LiDAR 5 is 1 m to 100 m, whereas the measurement distance range of the FMCW LiDAR 7 is 1 m to 1.5 m or 2 m to 3 m. Therefore, in the distance measurement device 1, the distance measured by the ToF LiDAR 5 is used for adjusting a focus adjustment mechanism 37 of the FMCW LiDAR 7.

FIG. 2 is a diagram showing a configuration of the ToF LiDAR 5. It should be noted that, although not shown in FIG. 2, the ToF LiDAR 5 is controlled by the control device 9.

The ToF LiDAR 5 includes a laser light source 21, the scanning unit 23, and a photodetector 25.

The laser light source 21 is a light source that emits laser light P having an optical pulse. The wall surface T is sequentially irradiated with the laser light P, which is emitted from the laser light source 21, by the scanning unit 23 while changing a scanning angle θ. The laser light source 21 is configured with, for example, a light-emitting source using a laser diode (LD). The control device 9 controls the laser light source 21 to emit the optical pulse to the laser light source 21. The laser light source 21 emits the laser light P in a specific wavelength range. The wavelength range to be used may be a visible range or an infrared range. It should be noted that the laser light source 21 is not limited to a semiconductor laser light source such as the laser diode, and may be other types of light sources. The laser light P emitted from the laser light source 21 is incident on the scanning unit 23.

The scanning unit 23 changes an emission direction of the laser light P emitted from the laser light source 21 in two dimensions in accordance with the control of the control device 9. For example, the scanning unit 23 sequentially irradiates the scanning line 15 (FIG. 1) of the wall surface T with the laser light P. The scanning unit 23 is composed of, for example, a polygon mirror and a motor that rotates the polygon mirror, and laser light for measurement is incident on the polygon mirror. The scanning unit 23 rotates the polygon mirror in a direction around a first axis by a motor to rotate (turn) the laser light for measurement reflected by the polygon mirror. As a result, the surface of the wall surface T is scanned with the laser light for measurement. In addition, the scanning unit 23 receives reflected light Q of the emitted laser light reflected by the wall surface T. The reflected light Q received by the scanning unit 23 is detected by the photodetector 25.

The photodetector 25 is disposed to detect reflected light Q including a reflected light pulse generated by the reflection of the optical pulse from the object, which is emitted from the laser light source 21. The photodetector 25 detects the reflected light Q to output a detection signal.

A ToF LiDAR processing unit 110A (FIG. 4) implemented by a processor 110 in the control device 9 controls the laser light source 21 and the photodetector 25 and processes the detection signal output from the photodetector 25 by executing the program stored in the memory 120. Specifically, the ToF LiDAR processing unit 110A outputs the distance to the wall surface T based on information on an emission timing of the laser light pulse emitted from the laser light source 21 and the detection signal indicating the intensity of the light received by the photodetector 25. It should be noted that the distance is stored in table data D of the memory 120 in association with the scanning angle θ and the positional information of the scanning unit 23.

### <FMCW LiDAR>

Hereinafter, the FMCW LiDAR 7 will be described. The FMCW LiDAR 7 can measure the distance to the measurement object with high accuracy, but it is necessary to focus on the measurement object with high accuracy. Here, since the distance measurement device 1 focuses the FMCW LiDAR 7 based on the distance acquired by the ToF LiDAR 5, it is possible to perform distance measurement robust to the change in the distance to the measurement object with high accuracy.

FIG. 3 is a diagram showing a configuration of the FMCW LiDAR 7. It should be noted that, as the FMCW LiDAR 7, a LiDAR using a frequency-shifted feedback laser (FSF laser) that is a type of FMCW LiDAR is suitably used.

The FMCW LiDAR 7 shown in FIG. 3 includes a laser light source 31, an interference optical system including a beam splitter 35 and a reference mirror 41, the scanning unit 39, and a photodetector 43. It should be noted that a distance from the center of the beam splitter 35 to the reference mirror 41 and a distance from the center of the beam splitter 35 to the scanning unit 39 are designed to be equal to each other.

The laser light source 31 may be, for example, an FSF laser that oscillates by inserting an acousto-optic modulator (AOM), which is a frequency-shifting element, into the resonator and feeding back the first-order diffracted light whose frequency has been shifted by the AOM.

The FSF laser light emitted from the laser light source 31 is split into the laser light for measurement and laser light for reference by the beam splitter 35, and the laser light for reference is reflected by the reference mirror 41 and is incident on the beam splitter 35 again.

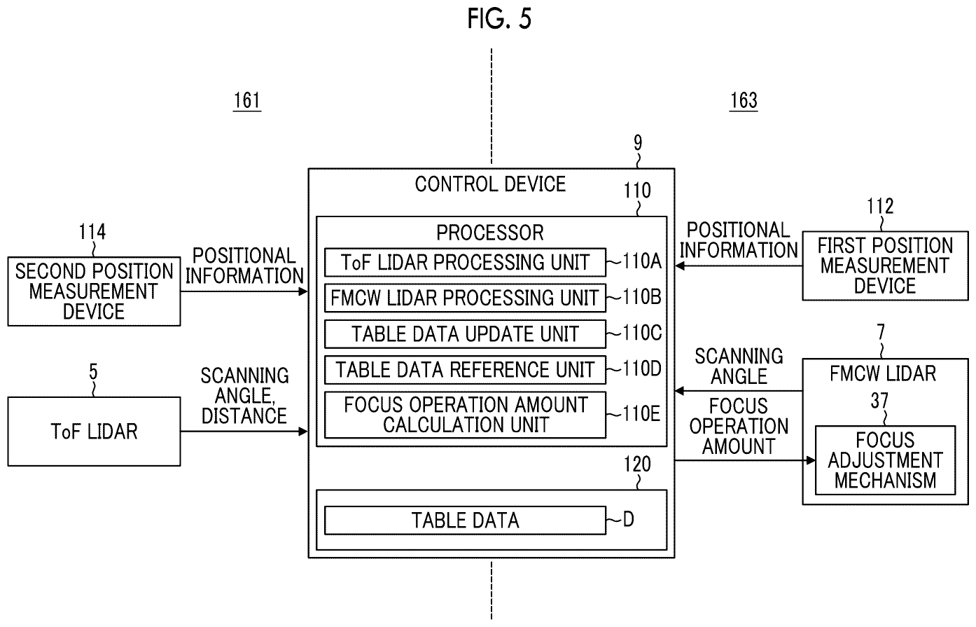

Meanwhile, the laser light for measurement is transmitted through the focus adjustment mechanism 37 and is incident on the scanning unit 39. Here, the focus adjustment mechanism 37 has a function of adjusting the focus position of the laser light for measurement and condensing the laser light for measurement on the surface of the measurement object. For example, the focus adjustment mechanism 37 adjusts the focus position of the laser light for measurement by moving a focus lens along an optical axis direction. It should be noted that a moving amount of the focus adjustment mechanism 37 is input from the control device 9 as a focus operation amount (see FIG. 5). It should be noted that a specific aspect of the focus adjustment mechanism 37 is not limited to the adjustment of the focus position by the movement of the focus lens in the optical axis direction. For example, the focus position may be changed by changing a curvature R of a spherical surface of a lens by a liquid lens. In addition, the scanning unit 39 is composed of, for example, a polygon mirror and a motor that rotates the polygon mirror, and laser light for measurement is incident on the polygon mirror. The scanning unit 39 rotates the polygon mirror in a direction around a first axis by a motor to rotate (turn) the laser light for measurement reflected by the polygon mirror. As a result, the surface of the wall surface Tis scanned with the laser light for measurement (the scanning line 17 (FIG. 1) of the wall surface T is sequentially irradiated with the laser light for measurement). In addition, a rotation speed of the polygon mirror in the direction of the first axis can be, for example, 4000 rpm.

The laser light for measurement (signal light) reflected by the surface of the wall surface Tis incident on the beam splitter 35 again through the scanning unit 39 and the focus adjustment mechanism 37. The signal light incident on the beam splitter 35 and reference light reflected by the reference mirror 41 (reference surface) and incident on the beam splitter 35 are combined by the beam splitter 35 and output as interference light.

The photodetector 43 performs photoelectric conversion on the interference light output from the beam splitter 35, to detect an interference signal indicating the interference light. The interference signal detected by the photodetector 43 is input to an FMCW LiDAR processing unit 110B of the control device 9.

The FMCW LiDAR processing unit 110B (FIG. 4) implemented by the processor 110 in the control device 9 processes the interference signal output from the photodetector 43 by executing the program stored in the memory 120. Specifically, the FMCW LiDAR processing unit 110B detects a beat frequency in the interference signal by frequency analysis, and acquires the distance to the wall surface T based on the detected beat frequency. The distance acquired in this manner is more accurate than the distance information acquired by the ToF LiDAR 5, and is suitably used for obtaining the three-dimensional shape up to the wall surface T.

### <Control Device>

Hereinafter, the control device 9 will be described. The control device 9 is configured with, for example, a computer or a microcomputer.

FIG. 4 is a block diagram showing a hardware configuration example of the control device 9 and main functions implemented by the processor 110.

The control device 9 comprises the processor 110, the memory 120, a display 130, an input/output interface 140, and an operation unit 150.

The processor 110 is configured with a central processing unit (CPU) or the like, and integrally controls the respective units of the control device 9 and performs control of the distance measurement of the distance measurement device 1. The processor 110 includes the ToF LiDAR processing unit 110A, the FMCW LiDAR processing unit 110B, a table data update unit 110C, a table data reference unit 110D, and a focus operation amount calculation unit 110E.

The memory 120 includes a flash memory, a read-only memory (ROM), a random-access memory (RAM), a hard disk drive, and the like. The flash memory, the ROM, or the hard disk drive is a non-volatile memory that stores various programs including an operating system and the like. The RAM functions as a work area of the processing executed by the processor 110 and temporarily stores the programs and the like stored in the flash memory and the like. It should be noted that a part (RAM) of the memory 120 may be built in the processor 110.

The display 130 displays an image in accordance with the control of the processor 110. In addition, the display 130 is also used as a part of a graphical user interface (GUI) in a case in which various types of information are received from the operation unit 150.

The input/output interface 140 includes a connection unit that can be connected to an external device, a communication unit that can be connected to a network, and the like. The input/output interface 140 can be connected to the external device and the network in a wired or wireless manner. For example, the input/output interface 140 connects the ToF LiDAR 5, the FMCW LiDAR 7, the first position measurement device 112, and the second position measurement device 114.

Here, the first position measurement device 112 measures the positional information (first positional information) of the FMCW LiDAR 7, and the second position measurement device 114 measures the positional information (second positional information) of the ToF LiDAR 5. Specifically, the first position measurement device 112 and the second position measurement device 114 measure the positional information by measuring a moving distance of the cart 3 or measuring a moving speed of the cart 3 and an elapsed time. For example, a rotation speed measurement sensor is attached to a wheel of the cart 3, and the moving distance or the moving speed of the cart 3 is measured based on a rotation speed of the wheel obtained from the rotation speed measurement sensor. It should be noted that the first position measurement device 112 and the second position measurement device 114 may be an integrated device. In addition, the acquisition method of the positional information of the first position measurement device 112 and the second position measurement device 114 is not limited to the above-described example, and the positional information may be acquired by another method. For example, the first position measurement device 112 and the second position measurement device 114 may acquire the positional information by using a global positioning system (GPS).

The operation unit 150 includes a pointing device such as a mouse, a keyboard, and the like, and functions as a part of the GUI that receives various types of information and instructions input by a user operation.

### <Control of Focus Adjustment Mechanism>

Hereinafter, the control of the focus adjustment mechanism 37 of the FMCW LiDAR 7 performed by the control device 9 will be described.

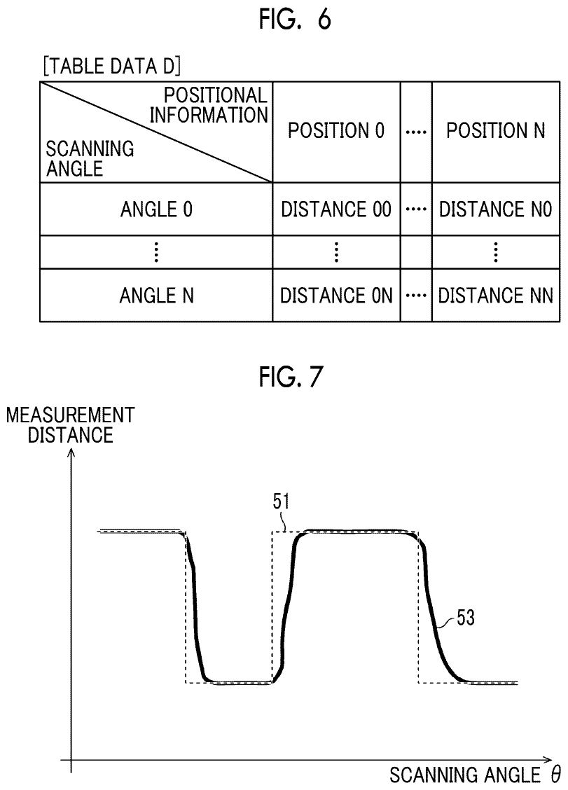

FIG. 5 is a diagram showing the control of the focus adjustment mechanism 37 in the distance measurement device 1. In addition, FIG. 6 is a diagram showing a storage configuration example of the table data D stored in the memory 120.

First, a distance acquisition step will be described using a diagram shown by reference numeral 161 in FIG. 5.

In the distance acquisition step, the distance to the wall surface Tis acquired by the ToF LiDAR 5. The ToF LiDAR 5 acquires the distance for each of a certain scanning angle of the scanning unit 23. Then, the ToF LiDAR 5 transmits the distance to the control device 9 in association with the scanning angle. For example, the scanning unit 23 changes the scanning angle in a range of an angle 0 to an angle N, and the ToF LiDAR 5 transmits the measurement distance from the angle 0 degree to the angle N degree to the control device 9 in association with the scanning angle. In addition, the second position measurement device 114 acquires the positional information of the ToF LiDAR 5 from the moving distance. The second position measurement device 114 measures the positions (position 0 to position N) of the ToF LiDAR 5 in a case in which the distance is acquired by the ToF LiDAR 5. Then, the table data update unit 110C of the control device 9 acquires the scanning angle from the ToF LiDAR 5, the distance associated with the scanning angle, and the positional information of the ToF LiDAR 5 from the second position measurement device 114, and updates the table data D (see FIG. 6) of the memory 120. In the table data D, the distance is stored in association with the scanning angle and the positional information as shown in FIG. 6.

As described above, in the distance acquisition step, the distance to the measurement object is acquired by using the ToF LiDAR 5, and the table data D is updated.

Hereinafter, a focus control step will be described with reference to a diagram shown by a reference numeral 163 in FIG. 5.

In the focus control step, the focus adjustment mechanism 37 is operated using the distance of the table data D, and the focus position of the FMCW LiDAR 7 is aligned with the wall surface T.

The first position measurement device 112 acquires the positional information of the FMCW LiDAR 7 from the moving distance. The first position measurement device 112 measures the positions (position 0 to position N) of the FMCW LiDAR 7 in a case in which the distance is acquired by the FMCW LiDAR 7. Here, the position of the FMCW LiDAR 7 corresponds to the position of the ToF LiDAR 5. In addition, the FMCW LiDAR 7 transmits the scanning angle during the measurement to the control device 9. Then, the table data reference unit 110D acquires (refers to) the distance from the table data D based on the positional information acquired from the first position measurement device 112 and the scanning angle acquired from the FMCW LiDAR 7. The table data reference unit 110D sets the acquired distance as a focus target value of the focus adjustment mechanism 37. It should be noted that, in the table data reference unit 110D, a processing unit may be provided, which performs state prediction such as a Kalman filter between the step of acquiring the distance from the table data D and the step of setting the acquired distance to the focus target value. The focus operation amount calculation unit 110E calculates an operation amount for driving the focus adjustment mechanism 37 based on the distance acquired by the table data reference unit 110D and the parameters of the focus adjustment mechanism 37 of the FMCW LiDAR 7, and transmits the operation amount to the focus adjustment mechanism 37 of the FMCW LiDAR 7. The focus adjustment mechanism 37 receives the focus operation amount, and moves the focus adjustment mechanism 37 based on the focus operation amount. In this way, the focus adjustment mechanism 37 adjusts the focus position based on the distance stored in the table data D.

In this way, in the focus control step, the distance of the table data D is acquired, and the focus adjustment mechanism 37 is driven to align the focus position of the FMCW LiDAR 7 with the wall surface T. Accordingly, the FMCW LiDAR 7 of the distance measurement device 1 can perform the measurement robust to the change in the distance to the wall surface T. In addition, since the distance is acquired in a state in which the focus position of the FMCW LiDAR 7 of the distance measurement device 1 is aligned to the wall surface T, an SN ratio of the interference signal is increased, and thus the distance can be more accurately acquired.

FIG. 7 is a diagram showing the distance to the wall surface T measured by the ToF LiDAR 5 and the distance to the focus position of the FMCW LiDAR 7. It should be noted that, in the graph shown in FIG. 7, a vertical axis indicates the distance, and a horizontal axis indicates the scanning angle θ at the position Z of the cart 3.

A dotted line 51 indicates the distance to the wall surface T acquired by the ToF LiDAR 5. In addition, a solid line 53 indicates the focus position of the FMCW LiDAR 7. The focus adjustment mechanism 37 of the FMCW LiDAR 7 drives the focus adjustment mechanism 37 based on the measurement result of the ToF LiDAR 5, to adjust the focus. Meanwhile, the distance measurement of the FMCW LiDAR 7 is performed independently of the driving of the focus adjustment mechanism 37. That is, in a case in which the measurement is performed at a high speed, the distance measurement of the FMCW LiDAR 7 is performed without waiting for the focus adjustment mechanism 37. In such a case, as shown in FIG. 7, a deviation occurs between the distance to the wall surface T acquired by the ToF LiDAR 5 and the focus position of the FMCW LiDAR 7. However, after the occurrence of the deviation, the focus position is immediately adjusted to the distance to the wall surface T. Accordingly, even in a case in which the FMCW LiDAR 7 performs high-speed measurement, the focus position can be finally set to the wall surface T, and the distance measurement device 1 can measure the distance to the wall surface T with high accuracy. In a case described in FIG. 7, the measurement is performed at a high speed. In a case in which the accuracy is prioritized over the speed of measurement, the distance measurement may be performed by the FMCW LiDAR 7 after the focus adjustment mechanism 37 is moved to the focus target value.

### <Distance Measurement Method>

Hereinafter, a distance measurement method using the distance measurement device 1 will be described.

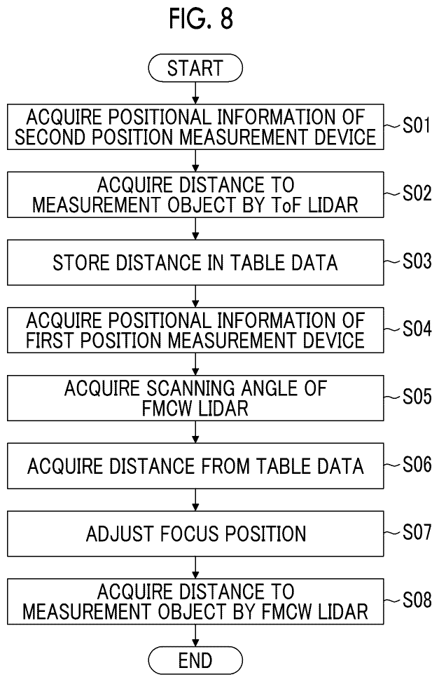

FIG. 8 is a flowchart showing the distance measurement method using the distance measurement device 1. It should be noted that the distance measurement method is performed by executing a dedicated program via the processor 110 of the distance measurement device 1.

First, the table data update unit 110C acquires the positional information of the ToF LiDAR 5 output by the second position measurement device 114 (step S01). Then, the ToF LiDAR 5 acquires the distance to the measurement object (wall surface T) (step S02). Then, the table data update unit 110C acquires the distance to the measurement object associated with the scanning angle of the scanning unit 23 of the ToF LiDAR 5, which is output by the ToF LiDAR 5, and stores the distance in accordance with the scanning angle and the positional information in the table data D (step S03).

Then, the table data reference unit 110D acquires the positional information of the FMCW LiDAR 7 output by the first position measurement device 112 (step S04). In addition, the table data reference unit 110D acquires the scanning angle of the scanning unit 39 of the FMCW LiDAR 7 (step S05). Then, the table data reference unit 110D acquires the distance corresponding to the scanning angle of the scanning unit 39 of the FMCW LiDAR 7 and the positional information output by the first position measurement device 112, with reference to the table data D (step S06). Then, the focus operation amount calculation unit 110E calculates the focus operation amount based on the distance acquired with reference to the table data D, and transmits the focus operation amount to the focus adjustment mechanism 37. Then, the focus adjustment mechanism 37 adjusts the focus adjustment mechanism 37 based on the focus operation amount (step S07). Then, the distance to the wall surface Tis acquired by the FMCW LiDAR 7 in a state in which the focus position is aligned with the wall surface T (step S08).

As described above, the distance measurement device 1 acquires the distance to the wall surface T by the FMCW LiDAR 7 in which the focus position is adjusted based on the distance acquired by the ToF LiDAR 5. Accordingly, the distance measurement device 1 is robust to the change in the distance to the wall surface T, and even in a case in which the shape of the wall surface T is changed, the focus position is aligned with the wall surface T, and the SN ratio of the interference signal is increased, so that the distance can be accurately acquired.

### Modification Example

Hereinafter, a modification example of the control of the focus adjustment mechanism 37 will be described.

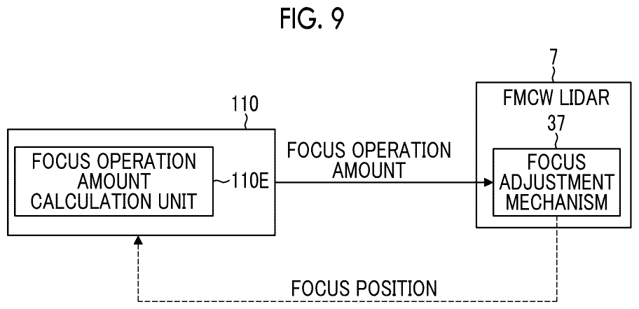

FIG. 9 is a diagram showing the control of the focus adjustment mechanism 37 of the present example.

In the above description, an example has been described in which the focus operation amount calculation unit 110E calculates the focus operation amount using the distance of the table data D as the target value. The calculated focus operation amount is transmitted to the focus adjustment mechanism 37, and the focus adjustment mechanism 37 is driven based on the focus operation amount.

On the other hand, in the present example, the focus operation amount calculation unit 110E performs closed-loop control of calculating the focus operation amount based on the focus position fed back from the focus adjustment mechanism 37, in addition to the calculation of the focus operation amount using the distance of the table data D as the target value.

In this way, by performing the closed-loop control, the focus adjustment mechanism 37 can perform control with higher accuracy of the focus position.

### <Others>

In the above-described embodiment, the hardware structures of processing units (ToF LiDAR processing unit 110A, FMCW LiDAR processing unit 110B, table data update unit 110C, table data reference unit 110D, and focus operation amount calculation unit 110E) that execute various types of processing are various processors as described below. The various processors include a central processing unit (CPU), which is a general-purpose processor that executes software (program) and functions as the various processing units, a programmable logic device (PLD), which is a processor of which a circuit configuration can be changed after manufacture, such as a field programmable gate array (FPGA), and a dedicated electric circuit, which is a processor of which a circuit configuration is designed for exclusive use in order to execute specific processing, such as an application specific integrated circuit (ASIC).

One processing unit may be configured by one of these various processors, or may be configured by two or more processors of the same type or different types (for example, a plurality of FPGAs, or a combination of a CPU and an FPGA). Moreover, a plurality of processing units may be configured by one processor. As a first example the configuration of the plurality of processing units by one processor, there is a form in which one processor is configured by combining one or more CPUs and software, and this processor functions as the plurality of processing units, as represented by a computer, such as a client or a server. Second, there is a form in which a processor, which achieves the functions of the entire system including the plurality of processing units with one integrated circuit (IC) chip, is used, as represented by a system on chip (SoC) or the like. In this manner, various processing units are configured by one or more of the various processors described above, as the hardware structure.

Further, the hardware structure of these various processors is, more specifically, an electric circuit (circuitry) in which circuit elements, such as semiconductor elements, are combined.

### Supplementary Note

The contents disclosed above include, for example, the contents of the following invention.

### (Aspect 1)

A distance measurement device comprising: a first distance measurement sensor; a second distance measurement sensor; and a processor, in which the first distance measurement sensor is a frequency-modulated continuous wave (FMCW) LiDAR, and includes a focus adjustment mechanism that adjusts a focus position of laser light for measurement and that focuses the laser light for measurement on a surface of a measurement object, the second distance measurement sensor is configured as a LiDAR having lower measurement accuracy and a wider measurement distance range than the first distance measurement sensor, and the processor is configured to control the focus adjustment mechanism based on a distance to the surface of the measurement object, which is obtained from the second distance measurement sensor.

### (Aspect 2)

The distance measurement device according to aspect 1, in which, in the first distance measurement sensor, a frequency-shifted feedback laser (FSF laser) is employed as the laser light for measurement.

### (Aspect 3)

The distance measurement device according to aspect 1 or 2, in which the second distance measurement sensor is configured as a time-of-flight (ToF) LiDAR.

### (Aspect 4)

The distance measurement device according to any one of aspects 1 to 3, further comprising: a first position measurement device that acquires first positional information of the first distance measurement sensor; and a second position measurement device that acquires second positional information of the second distance measurement sensor, in which the processor is configured to: acquire the distance in association with the second positional information; and acquire the distance based on the first positional information, to drive the focus adjustment mechanism.

### (Aspect 5)

The distance measurement device according to aspect 4, in which the first position measurement device and the second position measurement device are integrated together.

### (Aspect 6)

The distance measurement device according to any one of aspects 1 to 5, in which the second distance measurement sensor includes a scanner, and acquires the distance by changing an irradiation angle of laser light by the scanner, and the processor is configured to acquire the irradiation angle and the distance in association with each other.

### (Aspect 7)

The distance measurement device according to aspect 4 or 5, in which the first distance measurement sensor includes a scanner, and the processor is configured to acquire the distance based on a scanning angle of the scanner and the first positional information.

### (Aspect 8)

The distance measurement device according to any one of aspects 1 to 7, in which the measurement object is a concrete structure, a metal member, or a plastic member.

### (Aspect 9)

A distance measurement method of a distance measurement device including: a first distance measurement sensor; a second distance measurement sensor; and a processor, in which the first distance measurement sensor is a frequency-modulated continuous wave (FMCW) LiDAR, and includes a focus adjustment mechanism that adjusts a focus position of laser light for measurement and that focuses the laser light for measurement on a surface of a measurement object, and the second distance measurement sensor is configured as a LiDAR having lower measurement accuracy and a wider measurement distance range than the first distance measurement sensor, the distance measurement method comprising: a step of controlling, via the processor, the focus adjustment mechanism based on a distance to the surface of the measurement object, which is obtained from the second distance measurement sensor.

### (Aspect 10)

A program for executing a distance measurement method of a distance measurement device including: a first distance measurement sensor; a second distance measurement sensor; and a processor, in which the first distance measurement sensor is a frequency-modulated continuous wave (FMCW) LiDAR, and includes a focus adjustment mechanism that adjusts a focus position of laser light for measurement and that focuses the laser light for measurement on a surface of a measurement object, and the second distance measurement sensor is configured as a LiDAR having lower measurement accuracy and a wider measurement distance range than the first distance measurement sensor, the program causing the processor to execute a process comprising: a step of controlling the focus adjustment mechanism based on a distance to the surface of the measurement object, which is obtained from the second distance measurement sensor.

Each of the configurations and the functions described above can be implemented as appropriate by any hardware, software, or a combination thereof. For example, the present invention can be applied to a program causing a computer to execute the above-described processing steps (processing procedures), a computer-readable recording medium (non-transitory recording medium) on which such a program is recorded, or a computer in which such a program can be installed.

Although the examples of the present invention have been described above, it goes without saying that the present invention is not limited to the above-described embodiments, and various modifications can be made without departing from the gist of the present invention.

### EXPLANATION OF REFERENCES

1: distance measurement device
3: cart
5: ToF LiDAR
7: FMCW LiDAR
9: control device
13: railroad
21: laser light source
23: scanning unit
25: photodetector
31: laser light source
35: beam splitter
37: focus adjustment mechanism
39: scanning unit
41: reference mirror
43: photodetector
110: processor
110A: ToF LiDAR processing unit
110B: FMCW LiDAR processing unit
110C: table data update unit
110D: table data reference unit
110E: focus operation amount calculation unit
112: first position measurement device
114: second position measurement device
120: memory
130: display
140: input/output interface
150: operation unit

What is claimed is:

1. A distance measurement device that is moved by a mobile body, the distance measurement device comprising:
a first distance measurement sensor;
a second distance measurement sensor; and
a processor,
wherein the first distance measurement sensor is a frequency-modulated continuous wave (FMCW) LiDAR, and includes a focus adjustment mechanism that adjusts a focus position of laser light for measurement and that focuses the laser light for measurement on a surface of a measurement object,
the second distance measurement sensor is configured as a LiDAR having lower measurement accuracy and a wider measurement distance range than the first distance measurement sensor,
the processor is configured to control the focus adjustment mechanism based on a distance to the surface of the measurement object, which is obtained from the second distance measurement sensor, and
a measurement position on a surface of the measurement object by the second distance measurement sensor is positioned on a front side in a movement direction of the mobile body, relative to a measurement position on the surface of the measurement object by the first distance measurement sensor.

2. The distance measurement device according to claim 1,
wherein, in the first distance measurement sensor, a frequency-shifted feedback laser (FSF laser) is employed as the laser light for measurement.

3. The distance measurement device according to claim 1,
wherein the second distance measurement sensor is configured as a time-of-flight (ToF) LiDAR.

4. The distance measurement device according to claim 1, further comprising:
a first position measurement device that acquires first positional information of the first distance measurement sensor; and
a second position measurement device that acquires second positional information of the second distance measurement sensor,
wherein the processor is configured to:
acquire the distance in association with the second positional information; and
acquire the distance based on the first positional information, to drive the focus adjustment mechanism.

5. The distance measurement device according to claim 4,
wherein the first position measurement device and the second position measurement device are integrated together.

6. The distance measurement device according to claim 1,
wherein the second distance measurement sensor includes a scanner, and acquires the distance by changing an irradiation angle of laser light by the scanner, and
the processor is configured to acquire the irradiation angle and the distance in association with each other.

7. The distance measurement device according to claim 4,
wherein the first distance measurement sensor includes a scanner, and
the processor is configured to acquire the distance based on a scanning angle of the scanner and the first positional information.

8. The distance measurement device according to claim 1,
wherein the measurement object is a concrete structure, a metal member, or a plastic member.

9. A distance measurement method of a distance measurement device that is moved by a mobile body, the distance measurement device including: a first distance measurement sensor; a second distance measurement sensor; and a processor, in which the first distance measurement sensor is a frequency-modulated continuous wave (FMCW) LiDAR, and includes a focus adjustment mechanism that adjusts a focus position of laser light for measurement and that focuses the laser light for measurement on a surface of a measurement object, the second distance measurement sensor is configured as a LiDAR having lower measurement accuracy and a wider measurement distance range than the first distance measurement sensor, and a measurement position on a surface of the measurement object by the second distance measurement sensor is positioned on a front side in a movement direction of the mobile body, relative to a measurement position on the surface of the measurement object by the first distance measurement sensor, the distance measurement method comprising:
a step of controlling, via the processor, the focus adjustment mechanism based on a distance to the surface of the measurement object, which is obtained from the second distance measurement sensor.

10. A non-transitory, computer-readable tangible recording medium on which a program for causing, when read by a computer, a processor of the computer to execute the distance measurement method according to claim 9 is recorded.
